(19) United States
(12) Patent Application Publication
(10) Pub. No.: US 2005/0240991 A1
(43) Pub. Date: Oct. 27, 2005

(54) Secure data communication system

(76) Inventors: Kevin Eugene Dombkowski, Oswego, IL (US); Charles Arthur Witschorik, Naperville, IL (US)

Correspondence Address: WERNER ULRICH, 434 MAPLE STREET, GLEN ELLYN, IL, 60137-3826, US

(21) Appl. No.: 10/832,526

(22) Filed: Apr. 27, 2004

(51) Int. Cl. H04L 9/00

(52) U.S. Cl. 726/11

(57) ABSTRACT

This invention relates to methods and apparatus for securing communications between an open multimedia network and a trusted multimedia network. A multimedia boundary controller controls the communications between the two networks in order to intercept corrupting data such as viruses. The boundary controller contains an open network security engine for providing normal security and a trusted network security engine for implementing special software to provide additional protection. The unit is controlled by a secure processing unit which can prevent unwanted information from getting into the trusted network security engine and the trusted multimedia network. The secure processing unit communicates with a manufacturer of security software over the open network using encrypted messages. The encryption key is shared between the multimedia boundary controller and the manufacturer of software and is stored in a durable memory which can only be used directly by the secure processor's encryption software and hardware. Advantageously, this arrangement provides a high level of security for communications to and from a trusted multimedia network.

### TECHNICAL FIELD

This invention relates to methods and apparatus for securing data transmitted to or from a trusted data terminal or network.

### BACKGROUND OF THE INVENTION

As used herein, “trusted” means relatively secure from interference from an open network, and “secure” means the highest level of security, free from interference even from corrupted trusted networks. Transmission of data to trusted networks or terminals involves a never ending battle between “hackers” and providers of arrangements for preventing hackers from transmitting hacker data to a trusted terminal or network such as a protected personal computer (PC) or a private intranet network by intercepting hacker data before it can cause harm or preventing a hacker from an unauthorized reading of trusted data.

In accordance with the principles of the prior art, the primary arrangements of choice for foiling hackers is the use of firewalls between an open network and a trusted network and/or the use of encryption to prevent the unauthorized interception of data and to prevent unauthorized messages from being accepted by the trusted network or terminal. The problem with the first arrangement is that current hardware arrangements make it possible to update and thereby corrupt the programs in the firewall once the protections around the firewall software have been breached. Encryption has its own problems in the sense that keys for the users must be maintained secret and different keys are required for communications by different users.

Accordingly, a problem of the prior art is that the arrangements for providing data transmission between sources in an open network and sources in a trusted network or terminal are inadequate and/or inefficient.

### SUMMARY OF THE INVENTION

The above problem is solved and an advance is made over the teachings of the prior art in accordance with this invention wherein a multimedia boundary controller is interposed between the open network and the trusted network or terminal; at the heart of this boundary controller is an encryption/decryption device with a private key, or keys, of sufficient length so as to make unauthorized decryption of control messages from a supplier of security software essentially impossible. In accordance with one feature of the preferred embodiment, each private key is stored in a durable memory that can be read or written only within a secure processing unit (SPU). Control messages, including software updates, from a primary supplier of control software and data for the SPU which controls the operation of the multimedia boundary controller can be transmitted over the open multimedia network but require decryption using the private key(s) of the SPU. Advantageously, hackers cannot gain access to the control software and data of the SPU unless they are able to steal the private key(s) from the primary supplier or can perform the extremely difficult task of encrypting or decrypting messages without initially knowing the private key(s).

Many operations of the multimedia boundary controller are controlled by an open processing unit, access to which is controlled by an isolation unit that in turn is controlled by the secure processing unit. Security engines contain firewall software to block contaminating data from reaching the trusted network or device, and are interposed between the open network and the trusted network. Accordingly, hackers that succeed in accessing the open processing unit and contaminating its content can be prevented from spreading contamination by isolation of the open processing unit at the request of the SPU. Declaration of contamination in the open processing unit, to the SPU, can be done by the open processing unit, the SPU, the security engines, or human intervention at the local security interface of the boundary controller. By isolating the open processing unit, the SPU can prevent contaminated software from sending information to either the open or the trusted networks that are connected to the multimedia boundary controller. The SPU can also control the forced initialization of the open processing unit from protected software in the secure or trusted memory of the SPU. Such protected software could include methods of decontamination of the open processing unit.

Other operations that are more controlled than those assigned to the open processing unit can be performed by a trusted processor in the SPU. For example, software that implements corporate policy in the trusted network, such as periodic scans of open memory for viruses, could be assigned to the trusted processor. This software would be supplied by the owner of the trusted network or some other party and not necessarily by the supplier of the multimedia boundary controller. The trusted processor would be under final control of the secure processing unit and could be halted from operation or forced to initialize from secure memory if it were declared corrupted by the secure processor or a setting of the local security interface of the boundary controller.

A limited number of highly controlled, basic operations can be assigned to the secure processor. For example, the secure processor can implement a basic call processing engine that operates without the assistance of the trusted processor or the open processing unit. The basic call processing engine can support a limited interconnection of voice calls through the multimedia boundary controller, for example access to E-911 centers, when one or both of the open processing unit or trusted processor are declared contaminated. Communication between the secure processor of the SPU (SP of SPU) and the local security interface and the supplier of the multimedia boundary controller are also considered basic operations that are available at all times.

In accordance with one preferred embodiment of Applicants' invention, an open network security engine is provided in line with the data from and to the open multimedia network. The open network security engine implements firewall processes, for example, to intercept viruses being transmitted to the trusted multimedia network or data terminal. In addition, a trusted network security engine, which can contain different firewall protections, is provided in series with a communications to the trusted multimedia network or terminal. This trusted security engine can implement additional firewall rules aimed at the type of data likely to be transmitted to or from the trusted multimedia network or terminal.

In the preferred embodiment, a human interface, a local security interface, is provided to display the present status of the security settings of the multimedia boundary controller and to change these settings by, for example, pushing switches or buttons, or through some other commonly used input interface.

### BRIEF DESCRIPTION OF THE DRAWING(S)

FIG. 1 is a block diagram of a multimedia boundary controller in accordance with the principles of this invention;

FIG. 2 illustrates the relationship between a primary supplier of software for the secure processing unit (SPU) and the SP; and

FIG. 3 is a detailed functional diagram of the SPU.

### DETAILED DESCRIPTION

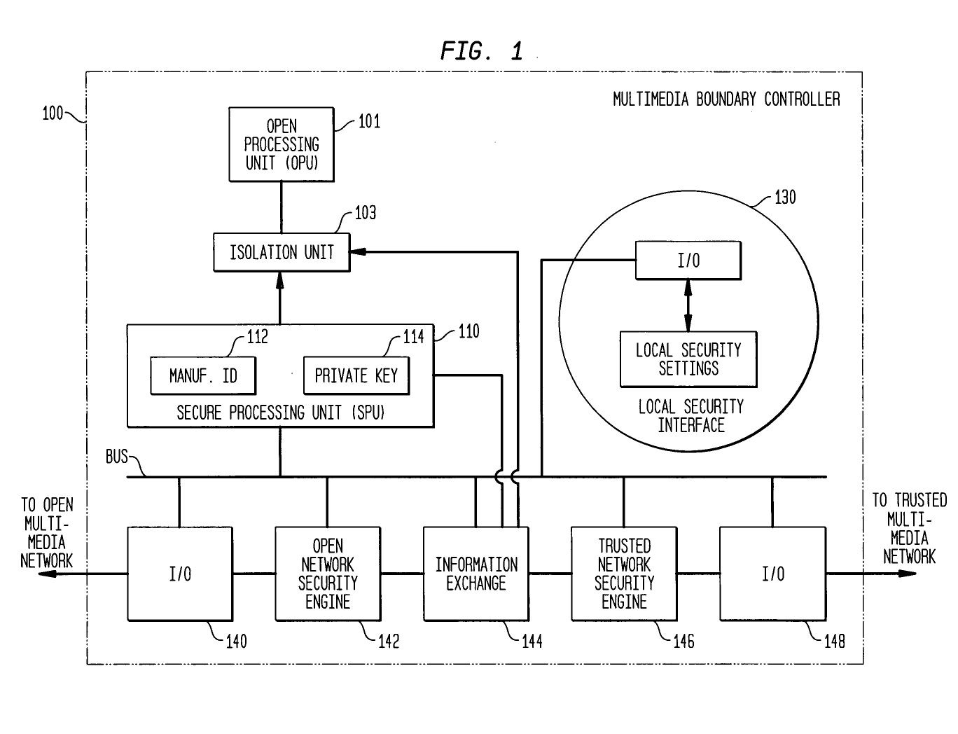

FIG. 1 is a block diagram of a multimedia boundary controller. It is shown as being interposed between an open multimedia network and a trusted multimedia network. The networks need not be multimedia and the trusted multimedia network can simply be a trusted terminal. The basic function of the multimedia boundary controller is to provide for secure communications from and to the open network and from and to the trusted network. Within the multimedia boundary controller is an open processing unit 101 and a secure processing unit 110. These are the basic control units of the multimedia boundary controller with the secure processing unit having ultimate control through its control of an isolation unit 103 which passes or blocks memory updates to the open processing unit. The SPU is able to control and monitor all other elements of the multimedia boundary controller through the use of control mechanisms such as electrical communication buses. The control and monitor mechanism is used by the SP of SPU to send commands, queries, and responses to requests to other elements. The control and monitor mechanism is used by other elements to send responses to commands or queries or requests to the SP of SPU.

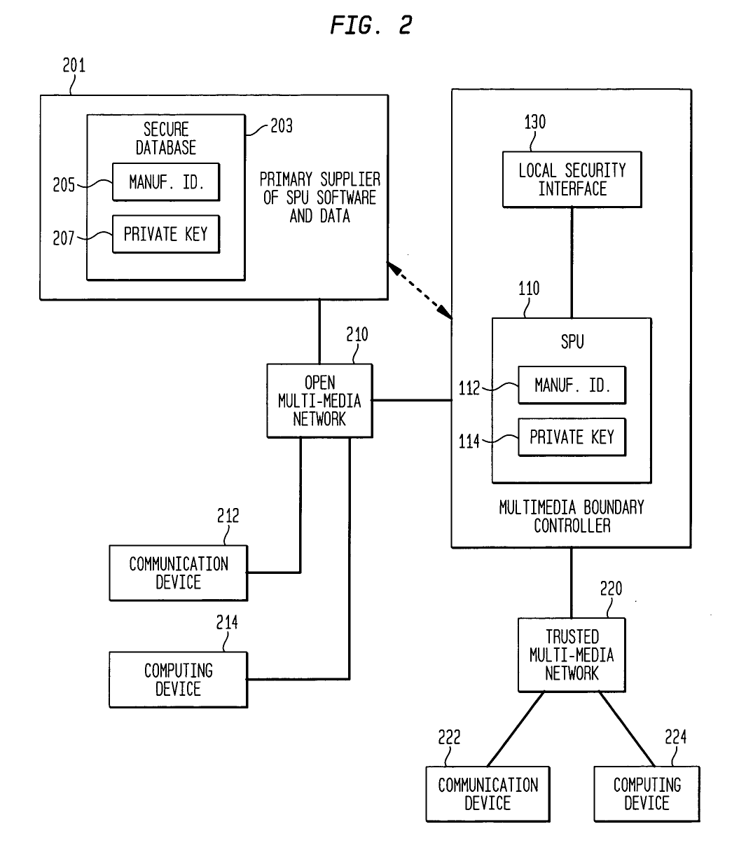

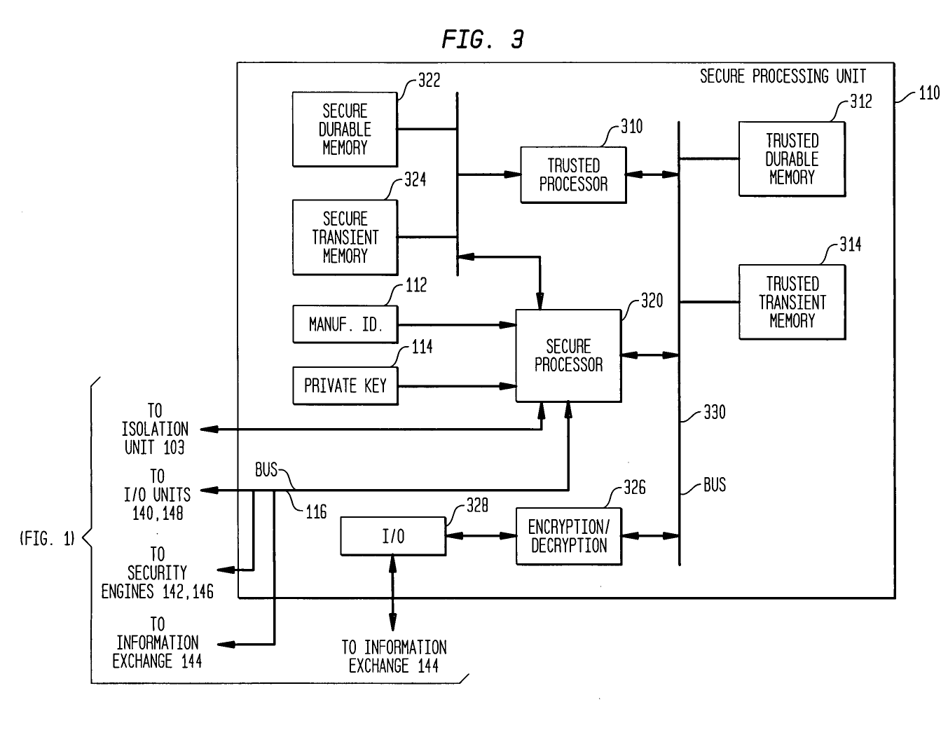

The open processing unit and the secure processing unit communicate via packet exchanges. The isolation unit is used under the control of the secure processing unit to prevent unwanted data from reaching or leaving the open processing unit. The open processing unit 101 and a trusted processor 310 (FIG. 3) within the SPU run application programs under an operating system. The SP of the SPU runs its own operating systems and provides support for the applications and operating systems of the open processing unit and the SPU trusted processor. Only the secure processor 320 within the secure processing unit can communicate with a primary supplier (201, FIG. 2) of secure processing unit software and/or data. Messages from and to the primary supplier are identified by the manufacturer's identification which is stored within the secure processing unit. All messages between the primary supplier and the SP of the SPU are encrypted using private key values that are available only the primary supplier and the SP of the SPU. An encryption/decryption engine (326, FIG. 3) within the SPU is used to convert the messages into a format acceptable to the SP of the SPU. All program updates are sent via encrypted messages and cannot be read in the clear from the secure memory of the SPU. This encryption of the SP of the SPU programs and their installation commands makes it extremely difficult, excluding unauthorized access to the secure databases of the primary supplier, to reverse-engineer and re-install the programs of the secure processor with the intention of exploiting security holes.

In addition, the secure processing unit provides a series of well-defined processing operations including emergency call processing, basic information transfer, basic overload control, and fundamental responsibility for the uncorrupted sanity of the entire multimedia boundary controller. The well-defined processing operations provide a fail-safe foundation for continued emergency communication and recovery after corruption of the open processing unit or the trusted processor within the SPU. For example, well-known methods of sanity testing can be implemented between the secure processing unit and other processing elements in the multimedia boundary controller. An algorithmic challenge can be issued to a processing unit with the expectation that an acceptable response to the challenge will be returned from the processing unit within a defined period of time. An incorrect or delayed response will cause the SPU to force the processing unit to initialize to a known state using software supplied from the secure memory of the processing unit. The secure processing unit is shown in more detail in FIG. 3.

FIG. 1 shows a connection to an open multimedia network via an input/output unit 140. This unit is connected to an open network security engine 142 which in turn is connected to an information exchange block 144. The information exchange block is a memory or fabric for implementing an interconnection function. The information exchange block 144 is connected to a trusted network security engine 146 which implements the security protocols of the trusted multimedia network. The trusted network security engine is connected an input/output unit 148 which is connected to the trusted multimedia network. In addition, the multimedia boundary controller contains a local security interface 130 having display and manual control capabilities for implementing human override control. The information exchange block is connected via isolation unit 103 with the open processing unit 101 and is also connected to the secure processing unit 110. Bus 116 is used to convey commands and queries among the connected unit. In addition, SPU 110 has a command output to isolation unit 103 to block transfer of data from or to the open processing unit 101.

FIG. 2 shows the connections between the primary supplier of secure processor unit software and data 201, the multimedia boundary controller 100, the open multimedia network 210 and its attached devices 212, 214, and the trusted multimedia network 220 and its devices 222, 224. The primary supplier of secure processor unit software and data includes in a secure database 203 the manufacturer's identification 205 and the private key(s) 207 used to communicate with the multimedia boundary controller 100. The primary supplier 201 uses the open multimedia network 210 to access the multimedia boundary control 100 transmitting and receiving encrypted update and recovery data. Data from the primary supplier can include updates to the software of the SP of the SPU, commands requesting actions such as initialize, and responses to requests from the SP of the SPU. Data from the SP of the SPU can include activity logs, alarms, and requests for software updates. The data transmitted over the open multimedia network is decrypted in the secure processing unit 110; this unit has in its secure database the manufacturer's identification 112 (identical to a manufacturer identification 205) and the private key(s) 114 used for communications with the primary supplier of secure processor unit software and data 201. The private key(s) 114 match the private key(s) 207. In this preferred embodiment, a symmetric algorithm for the keys is used wherein no public key is needed. This has the added value of providing authentication to both parties since no other parties can encode a message since they have no access to the private key(s) and there is no public key.

The nature of the open communications network is such that unauthorized parties may be able to intercept or interject messages between the trusted network and other parties. For example, unsolicited email messages with virus attachments are a common problem in an open network such as the Internet but trusted networks must often connect with the Internet to allow communication with parties that are not directly connected to the trusted network. An example of a trusted network is a corporate wide-area network that is used to interconnect multiple locations in a company, but that is also used to allow communication with the Internet. Security engines in the multimedia boundary controller are designed to block invalid communication between an open and a trusted network; the SPU in the multimedia boundary controller is designed to stop the spread of corruption that does reach in from the open network. If for example, the SPU determines through a message from a security engine that the open processing unit is attempting to send email messages with attached virus software, the SPU can isolate the open processing unit from the open and trusted networks and force it to be reinitialized with software taken from trusted or secure memory within the SPU. Open memory, which is assumed to now hold a virus, can be examined by software running from the SPU to remove the virus or declare the open memory as ‘isolated from access’ until human intervention can recover uncorrupted data.

The multimedia boundary controller communicates with the trusted multimedia network 220. The open multimedia network 210 communicates with simple communication devices 212 and communicating computing devices 214. Similarly, the trusted multimedia network communicates with communication device 222 and communicating computing device 224. The secure processing unit controls the trusted network security engine 146 and the open network security engine 142 via a local control/response interface 116.

FIG. 3 is a block diagram of the secure processing unit 110. The unit communicates with the open multimedia network via input/output unit 328, the Information Exchange, 144, the Open Network Security Engine, 142, and the I/O unit, 140. Information for a secure processor 320 is passed through I/O device 328 via encryption/decryption unit 326. The secure processing unit receives secure information about the manufacturer's identification 112 and the private key(s) 114. In the preferred embodiment, the manufacturer identification 112 and private key(s) 114 are supplied by the manufacturer as non-changeable memory. The private key(s) 114 are never exposed beyond the secure processor and the encryption/decryption unit. The private key(s) 114 cannot be transferred to either the I/O unit 328 or the control interface 330. The secure processor 320 can access the trusted durable memory 312 and trusted transient memory 314 as well as the secure durable memory 322 and the secure transient memory 324. A trusted processor 310 can read selected areas of the secure durable and secure transient memory but cannot write in these memories. The trusted processor 310 can access both the trusted durable memory and the trusted transient memory for reading and writing. The basic point is that the secure processing unit 110 has a secure processor 320 which is the only unit that can write into the secure durable memory and the secure transient memory. Information in these memories can be used to control the functions carried out by the trusted processor 310. As described earlier, the trusted processor executes programs for the trusted network; programs that can be supplied by parties other than the primary supplier of the multimedia boundary controller. The secure processor executes programs that can only be supplied by the primary supplier. The secure processor programs are meant to implement primary functions such as over-all system sanity and emergency call processing.

As a result of the ability to carry out the above-described functions, the secure processing unit can securely control operation of an entire multimedia boundary controller making it difficult for corruption to be inserted into any part of the controller; making it possible to isolate elements that do become corrupted, helping to prevent spread of the corruption; making it possible to initialize elements with uncorrupted images from secure memory, allowing a return to an uncorrupted state; all while continuing a secure, primary level of processing functionality.

The above description is of one preferred embodiment of Applicants'invention. Other embodiments will be apparent to those of ordinary skill in the art without departing from the scope of the invention. The invention is limited only by the attached claims.

1. Apparatus for providing a secure interface between an open network and a trusted network or device comprising:
a network security engine for providing an interface between said open network and said trusted network or device; and
a secure processing unit;
said secure processing unit for communicating with a supplier of software and data for said secure processing unit for controlling said secure processing unit;
said secure processing unit communicating with said security engine to control functions and data of said security engine to provide a highly reliable network security engine.

2. The apparatus of claim 1 wherein communications between said supplier of software and data for said secure processing unit and said secure processing unit are transmitted over said open network;
wherein said communications are encrypted; and
wherein one or more keys for encrypting and decrypting communications between said supplier of software and data and said secure processing unit are stored in durable memory that can be read or written only by said secure processing unit.

3. The apparatus of claim 1 wherein said secure interface comprises:
a secure processing unit and an open processing unit;
wherein said open processing unit performs non-secure functions for said secure interface.

4. The apparatus of claim 3 further comprising:
an isolation unit used by said secure processing unit to block communications between said open network and said open processing unit.

5. The apparatus of claim 1 wherein said secure interface comprises:
trusted memory and secure memory wherein said secure memory can only be written into by said secure processing unit.

6. The apparatus of claim 1 wherein said secure interface comprises:
an open network security engine and a trusted network security engine;
wherein said trusted network security engine implements functions for protecting said trusted security network.

7. A method of providing a secure interface between an open network and a trusted network or device comprising:
routing data over a trusted network security engine between said open network and said trusted network or device; and
controlling said trusted network security engine from a secure processing unit;
communicating between said secure processing unit and a supplier of software and data for said secure interface for controlling said secure processing unit;
communicating from said secure processing unit to said trusted network security engine to control functions and data of said trusted network security engine to provide a highly reliable trusted network security engine.

8. The method of claim 7 wherein communications between said supplier of software and data for said secure processing unit and said secure processing unit are transmitted over said open network;
further comprising the steps of encrypting said communications; and
storing one or more keys for encrypting and decrypting communications between said supplier of software and data and said secure processing unit in durable memory that can be read or written only by said secure processing unit.

9. The method of claim 7 further comprising the steps of:
performing security processing in a secure processing unit and an open processing unit;
wherein said open processing unit performs non-secure functions for said secure interface.

10. The method of claim 9 further comprising the step of:
transmitting communications between said open network and said open processing unit over an isolation unit controlled by said secure processing unit for blocking unwanted communications.

11. The method of claim 9 further comprising the step of:
storing data in a trusted memory and a secure memory of said secure interface;
wherein said secure memory can only be written into by said secure processing unit.

12. The method of claim 7 wherein data routed over said secure interface is routed via an open network security engine and a trusted network security engine;
wherein said trusted network security engine implements functions for protecting said trusted network.
